(19) United States
(12) Patent Application Publication
(10) Pub. No.: US 2008/0055354 A1
(43) Pub. Date: Mar. 6, 2008

(54) Record defect detection apparatus, record defect detection method and image recording apparatus

(75) Inventor: Yasuhiro Miyazaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/893,293

(22) Filed: Aug. 15, 2007

(30) Foreign Application Priority Data
Sep. 5, 2006 (JP) 2006-240779

(51) Int. Cl. B41J 29/393

(52) U.S. Cl. 347/19

(57) ABSTRACT

A lighting unit emits an illumination light onto a recording medium after performing a recording process onto the recording medium based on image data by jetting an ink from individual nozzles. An imaging unit images, by way of a lens, the surface of the recording medium illuminated with the illumination light by the lighting unit and outputs a detection image. A record defect judgment unit judges a presence or absence of an occurrence of a record defect based on a result of the comparison between the image data and detection image. In this configuration, the lighting unit provides the surface of the recording medium with an illuminance distribution compensating a nonuniformity of a brightness distribution in the detection image attributable to a shading characteristic of the lens by an illumination of the illumination light.

### CROSS REFERENCE TO RELATED APPLICATIONS

This application claims the benefit of Japanese Application No. 2006-240779 filed Sep. 5, 2006, the contents of which are incorporated by this reference.

### BACKGROUND OF THE INVENTION

1. Field of the Invention

The present invention relates to an image recording technique recording an image by fixing an ink in a recording medium such as paper and film, and in particular to a technique for detecting a record defect attributable to a nozzle equipped in a recording head of an image recording apparatus.

2. Description of the Related Art

Among image recording apparatus recording an image by fixing an ink on a recording medium such as a large volume of paper or film, some are configured to record an image of different content for each page while conveying a recording medium at a high speed of tens to hundreds meters per minute. In such a high speed image recording, it is not possible to confirm visually whether or not image data sent from a host apparatus matches with the post-record image. Consequently used in such an image recording apparatus is a technique reading a recorded image electronically and comparing the image, for pixel by pixel, with an image represented by the image data sent from the host apparatus, thereby detecting a record defect.

Related to such a technique, a Laid-Open Japanese Patent Application Publication No. H09-136411 for example has disclosed an invention aiming at carrying out a check of a print content in a printer apparatus printing different data for each print sheet in a high speed. The invention is configured to perform a “template matching” between the image data input to the printer apparatus and the content printed thereby and, if the difference between the two is no less than a predefined value, judges to be a print defect.

Another Laid-Open Japanese Patent Application Publication No. H10-318731 has disclosed an invention aiming at easing an inspection of a print defect of a variable character that is a different character being printed for each printing. According to the invention, a variable character printed by an inkjet printer on a zonal paper is photographed by a camera. Then the photographed image data is checked with the bit map data input to the inkjet printer, thereby inspecting the good or bad character printed on the paper.

According to both of the inventions disclosed in the two reference documents, it is necessary to carry out a matching process between the print image data input to the printer apparatus and the inspection image data of a result of reading the printed content in the unit of pixel.

Meanwhile, when implementing the above technique for detecting a record defect, a line illumination obtaining a uniform light intensity distribution on a straight line, such as a fluorescent tube, is sometimes used along with a lens and a charge coupled device (CCD) in order to read adequately the image recorded on a recording medium. Even with a use of such a line illumination, a non-uniform S/N characteristic occurs at ends of the light reception face of the CCD due to a decreased light intensity caused by a shading characteristic of a lens.

### SUMMARY OF THE INVENTION

A record defect detection apparatus according to one aspect of the present invention is one for detecting a record defect having occurred at the time of performing a recording process onto a recording medium, based on image data, by jetting an ink from individual nozzles of a nozzle array formed with a plurality of nozzles, comprising: a lighting unit for emitting an illumination light onto the recording medium after performing the recording process; an imaging unit for imaging, by way of a lens, the surface of the recording medium illuminated with the illumination light by the lighting unit and outputting a detection image; a conveyance unit for conveying the recording medium while maintaining a relationship of a position where the surface of the recording medium is opposite to the imaging unit; and a record defect judgment unit for judging a presence or absence of an occurrence of the record defect based on a result of the comparison between the image data and detection image, wherein the lighting unit provides the surface of the recording medium with an illuminance distribution compensating a nonuniformity of a brightness distribution in the detection image attributable to a shading characteristic of the lens by an illumination of the illumination light.

A record defect detection method according to one of other aspects of the present invention is the method for detecting a record defect having occurred at the time of performing a recording process on a recording medium, based on image data, by jetting an ink from individual nozzles of a nozzle array formed with a plurality of nozzles, comprising: obtaining processed image data recorded on the recording medium from the one for which the recording process is performed; calculating a first distribution that is a distribution of positions of dots which are to be actually recorded on the recording medium if the recording process is performed in accordance with the image data based on a result of binarizing data, pixel by pixel, for at least one line of the image data; calculating a second distribution that is a distribution of positions of dots recorded on the recording medium by performing the recording process based on a result of binalizing data, pixel by pixel, for at least one line of the processed image data; comparing the first distribution with the second distribution; and detecting the record defect based on the comparison result.

A record defect detection method according to one of yet other aspects of the present invention is the method for detecting a record defect having occurred at the time of performing a recording process on a recording medium, based on image data, by jetting an ink from individual nozzles of a nozzle array formed with a plurality of nozzles, comprising: obtaining processed image data recorded on the recording medium from the one for which the recording process is performed; calculating a first distribution that is a distribution of positions of dots which are to be actually recorded on the recording medium if the recording process is performed in accordance with the image data based on a result of binarizing data, pixel by pixel, for at least one line of the image data; calculating a brightness value of pixel data corresponding to the dots within the first distribution based on the image data; determining the grand total of first brightness values by calculating, for each nozzle, the grand total of the brightness values calculated for the dots within the first distribution; calculating the second distribution, which is the distribution of positions of dots recorded on the recording medium by performing the recording process, based on the processed image data; calculating brightness values of image data corresponding to the dots within the second distribution based on the processed image data; determining the grand total of second brightness values by calculating, for each nozzle, the grand total of the brightness values calculated for the dots within the second distribution; calculating, for each nozzle, a value of the ratio of the grand total of the first brightness values to that of the second brightness values; and detecting the record defect based on the value of the ratio.

An image recording apparatus according to one of yet other aspects the present invention is one performing a recording process onto a recording medium, based on image data, by jetting an ink from each nozzle of a nozzle array formed with a plurality of nozzles, comprising: a lighting unit for emitting an illumination light onto the surface of the recording medium after the recording process is performed; an imaging unit for outputting, by way of a lens, a detection image of the surface of the recording medium to which the illumination light is illuminated by the lighting unit; a conveyance unit for conveying the recording medium while maintaining a relationship of a position where the surface of the recording medium is opposite to the imaging unit; and a record defect judgment unit for judging a presence or absence of an occurrence of the record defect having occurred at the time of performing the recording process onto the recording medium based on a result of the comparison between the image data and detection image, wherein the lighting unit provides the surface of the recording medium with an illuminance distribution compensating a nonuniformity of a brightness distribution in the detection image attributable to a shading characteristic of the lens by an illumination of the illumination light.

### BRIEF DESCRIPTION OF THE DRAWINGS

The present invention will be more apparent from the following detailed description when the accompanying drawings are referred to.

FIG. 1 is a block diagram showing a conceptual configuration of a record defect detection apparatus according to a first preferred embodiment of the present invention;

FIG. 2 is a diagram showing a layout of individual constituent components of a record defect detection apparatus according to the first embodiment of the present invention;

FIG. 3A is a diagram showing a first example of a relationship of layout between an imaging unit and a lighting unit (part 1);

FIG. 3B is a diagram showing a first example of a relationship of layout between an imaging unit and a lighting unit (part 2);

FIG. 4A is a diagram showing an illuminance distribution within a reading range;

FIG. 4B is a diagram showing a shading characteristic, attributable to a lens, occurring on a light reception surface of a line sensor;

FIG. 4C is a diagram showing an intensity distribution of an illumination light on the light reception surface of a line sensor in the case of emitting an illumination light on a recording medium by placing an imaging unit and a lighting unit in the relationship as shown in FIGS. 3A and 3B;

FIG. 5A is a diagram showing a second example of a relationship of layout between an imaging unit and a lighting unit (part 1);

FIG. 5B is a diagram showing a second example of a relationship of layout between an imaging unit and a lighting unit (part 2);

FIG. 6 is a diagram showing a process content, in a flow chart, of a record defect detection process according to the first embodiment of the present invention;

FIG. 7A is a diagram showing an example of scan data obtained at a control unit (part 1);

FIG. 7B is a diagram showing a situation of the scan data exemplified in FIG. 7A being processed by the record defect detection process shown in FIG. 6;

FIG. 8 is a diagram showing a process content of a record defect detection section judgment process in a flow chart;

FIG. 9 is a diagram describing a record counter;

FIG. 10 is a diagram showing a process content, in a flow chart, of a record defect detection process according to a second preferred embodiment of the present invention;

FIG. 11A is a diagram showing an example of scan data obtained at a control unit (part 2);

FIG. 11B is a diagram showing a situation of the scan data exemplified in FIG. 11A being processed by the record defect detection process shown in FIG. 10;

FIG. 12 is a block diagram showing a conceptual configuration of an image recording apparatus embodying the present invention; and

FIG. 13 is a diagram showing a layout of individual constituent components of an image recording apparatus embodying the present invention.

### DESCRIPTION OF THE PREFERRED EMBODIMENTS

The following is a description of the preferred embodiment of the present invention by referring to the accompanying drawings.

Note that the following description defines the conveyance direction of a recording medium as feed direction, and the direction perpendicular to the conveyance direction as cross-feed direction.

The first is a description on a first preferred embodiment of a record defect detection apparatus embodying the present invention.

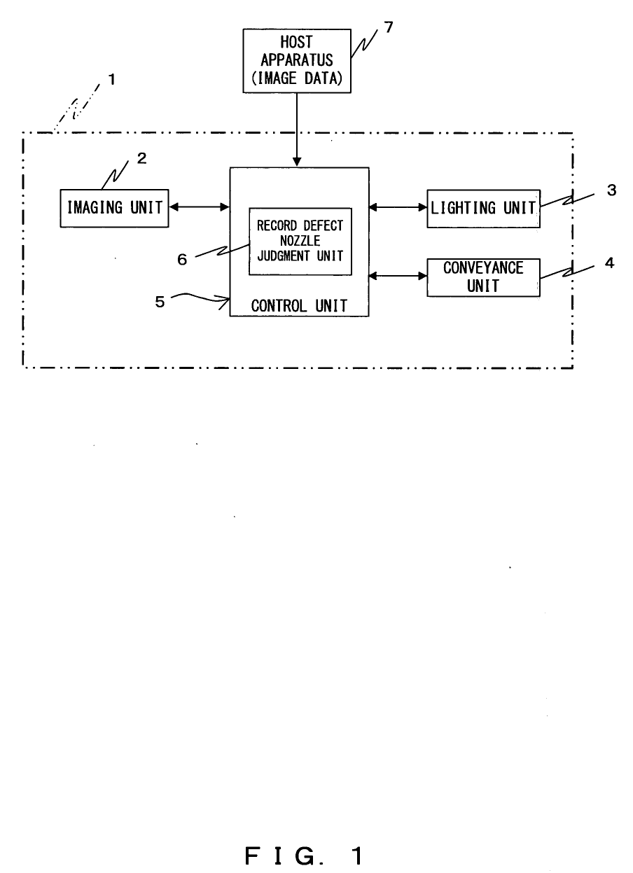

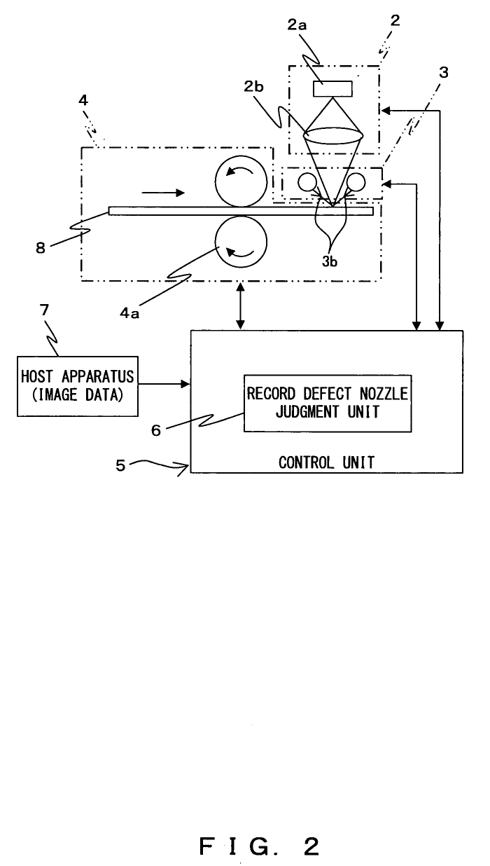

FIG. 1 is a block diagram showing a conceptual configuration of a record defect detection apparatus according to the present first embodiment; and FIG. 2 shows a layout of the individual constituent components of the record defect detection apparatus according to the present first embodiment.

A record defect detection apparatus 1 (also noted as “detection apparatus” hereinafter) according to the present embodiment is configured to detect a record defect having occurred at the time of performing a process for recording an image by fixing an ink on a recording medium such as paper and film based on image data sent from a host apparatus 7 transmitting original information to be recorded. The record defect detection apparatus 1 comprises at least an imaging unit 2, a lighting unit 3, a conveyance unit 4, a control unit 5 and a record defect nozzle judgment unit 6.

The imaging unit 2 is for picking up image (i.e., imaging) of the surface of the recording medium to which the recording process is applied as described above and converting the obtained image (i.e., the detection image) into digital data.

The lighting unit 3 illuminates a visible range of light on the surface of the recording medium to which the recording process is applied as described above and forms a light source surface of the second order for imaging.

The conveyance unit 4 moves the recording medium to which the recording process is applied as described above to the range of the effective field of vision of the imaging unit 2 and lighting unit 3.

The control unit 5 performs processes integrally, such as the timing control of the imaging unit 2, lighting unit 3 and conveyance unit 4 for imaging the recording medium, the pre-process for obtaining image data from the host apparatus 7 and for comparing with image data from the imaging unit 2 and an obtainment process of image data from the imaging unit 2. The control unit 5 also carries out a control process as the record defect nozzle judgment unit 6 of judging a presence or absence of a record defect having occurred at the time of performing a record process onto a recording medium. Note that the control unit 5 comprises a process circuit comprising a micro processor unit (MPU) that is an arithmetic logical operation apparatus (also noted as “operation apparatus” hereinafter) possessing a control function and an arithmetic logical operation function and a storage unit, such as read only memory (ROM), storing a control program, and nonvolatile memory (not shown in a drawing herein) storing a setup value, and such, related to the control of the detection apparatus. The control unit 5 makes the MPU read a prescribed control program from the storage unit and execute the program, thereby implementing the various control process described above.

Now a description of the respective constituent components of the record defect detection apparatus 1 is continued by referring to FIG. 2.

The conveyance unit 4 is placed in a manner that the recording medium 8 is moved to the feed direction by rotationally driving conveyance roller pair 4a, thus conveying the recording medium while maintaining the relationship of a position of the surface of the recording medium 8 being opposite to the imaging unit 2. And the conveyance unit 4 moves the recording process-applied recording medium 8 to the range of effective field of vision of the imaging unit 2 and lighting unit 3.

The lighting unit 3 is placed in a manner that the light reception area of a line sensor 2a comprised by the imaging unit 2 comprehends the field of vision projected on the recording medium 8, thereby illuminating it in a straight line (noted as “linearly” hereinafter). The lighting unit 3 is equipped with a light source emitting linearly as a light source for illuminating a long range in a linear uniform intensity of light. Such a light source can employ a fluorescent tube for example, or a linear array of light emitting diodes (LED), the use of which enables the detection apparatus to be compact. Incidentally, if a high speed imaging is necessary for speeding up a conveyance speed of the recording medium 8, an illumination of a larger intensity of light is required. In such a case, it is also possible to adopt a lighting unit configured to employ a Metal Halide Lamp for example as light source, lead the illumination light to the lighting unit by using an optical fiber and emit the illumination light linearly onto the recording medium.

The imaging unit 2 is incorporated with the line sensor 2a using a charge coupled device (CCD) and a lens 2b. Here, the individual pixels of the line sensor 2a are arrayed so that direction of the array is in the cross-feed direction when projected onto the surface of the recording medium 8. Therefore, the line sensor 2a is enabled to read continuously a two-dimensional image recorded on the recording medium conveyed by the conveyance unit 4. Meanwhile, a setup of a mutual distance among the recording medium 8, lens 2b and line sensor 2a makes it possible to obtain a desired resolution in accordance with the pitch of pixel array and optical magnification.

Note that the imaging unit 2 is placed so that the direction of the optical axis thereof is perpendicular to the surface of the recording medium 8. And the emission axis 3b (refer to FIG. 2) of the lighting unit 3 is placed so as to be 45 degrees for example in relation to the surface of the recording medium 8 within a place consisting of the feed direction and direction perpendicular to the surface of the recording medium 8. Such a placement prevents the regular reflection light of the illumination light on the surface of the recording medium from being incident to the imaging unit 2, thereby enabling the imaging unit 2 to pick up a good contrast image.

The control unit 5 and record defect nozzle judgment unit 6 can be placed in a position physically separated from the conveyance unit 4, imaging unit 2 and lighting unit 3. Image data from the host apparatus 7 is obtained at the control unit 5 which then compares with image data output from the imaging unit 2.

The record defect detection apparatus 1 is configured as described above. The record defect detection apparatus 1 has the line sensor 2a read an image recorded on the recording medium 8 based on the image data from the host apparatus 7, and compares the read image data with the image data from the host apparatus 7. And, based on the result of the comparison processing, the record defect detection apparatus 1 detects a record defect that is a result of an ink not being adequately jetted due to an ink clogging or malfunction of a nozzle, and an ink landing defect that is a result of the ink failing to land at a target position of the recording medium 8.

The next is a description on the lighting unit 3 in detail.

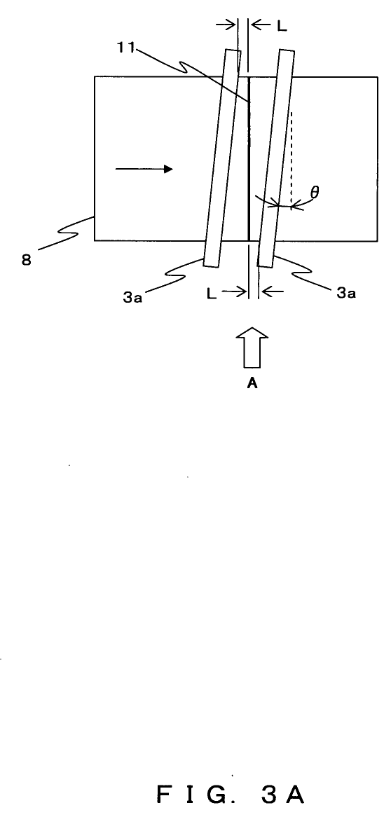

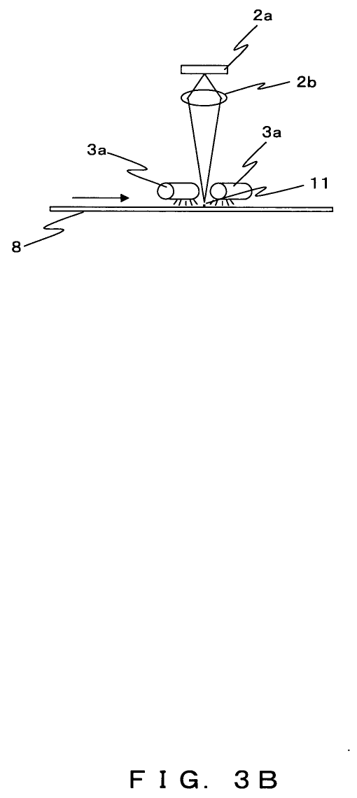

FIGS. 3A and 3B show a first example of a relationship of layout between the imaging unit 2 and lighting unit 3. FIG. 3A is a diagram viewed from a direction perpendicular to the surface of the recording medium 8 (i.e., the direction perpendicular to both of the cross-feed direction and feed direction), while FIG. 3B is a diagram viewed from the direction of the arrow A shown in FIG. 3A.

Referring to FIGS. 3A and 3B, a reading range 11 is an imaging range of the imaging unit 2 on the surface of the recording medium 8.

A light source pair 3a is two of a light source emitting light linearly. When viewing from a direction perpendicular to the surface of the recording medium 8, the light source pair 3a is placed so as to maintain the mutual relationship of positions across from the reading range 11 parallel, with the pair 3a being rotated by an angle of “θ” relative to the cross-feed direction. Here, the distance between the edge of the reading range 11 and one of the light source pair 3a (i.e., the one closer to the aforementioned edge) is set to be L when viewing from the direction perpendicular to the surface of the recording medium 8.

The next is a description on a reason for placing the light source pair 3a linearly emitting light as described above, that is, placing it mutually parallel and, at the same time, inclined relative to the cross-feed direction in the positions across from the reading range 11, while retaining it above the surface of the recording medium 8 and in parallel with the aforementioned surface.

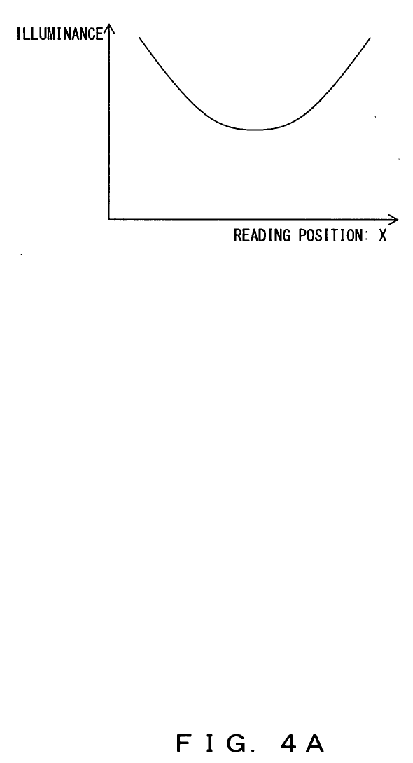

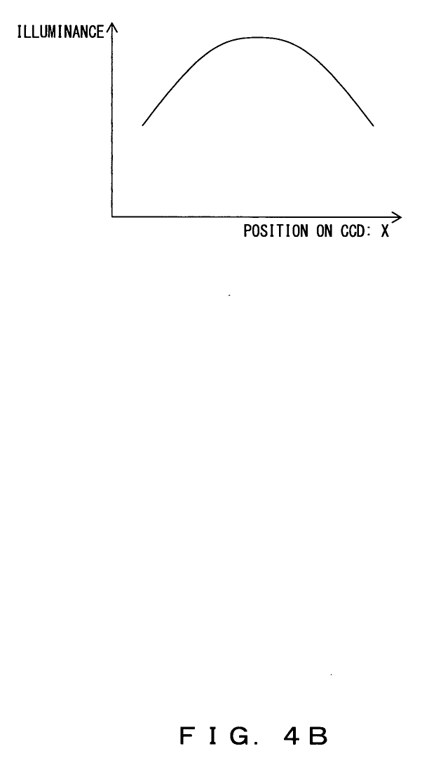

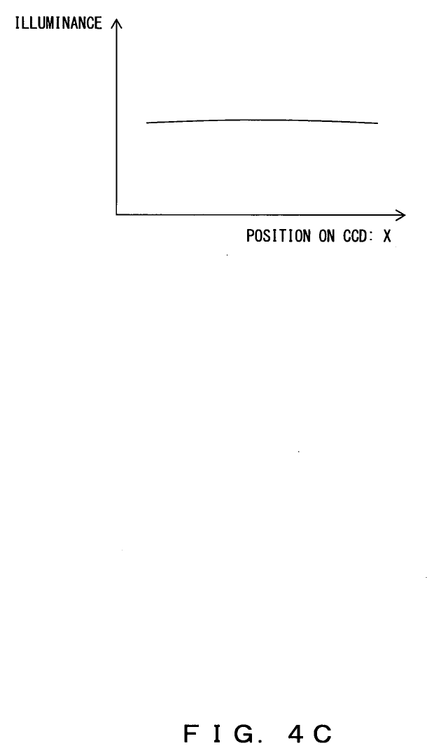

To begin with, a description is provided for FIG. 4A which shows an illuminance distribution in the reading range 11. The illuminance distribution is one when an illumination light is emitted on the recording medium by placing the imaging unit 2 and lighting unit 3 in a relationship as shown in FIGS. 3A and 3B.

Referring to FIG. 4A, the horizontal axis indicates the position in the cross-feed direction in the reading range 11 (i.e., the distance from the edge of one side of the reading range 11), and the vertical axis indicates the illuminance in the position. This diagram provides a comprehension that the illuminance is low in the center part, with a gradual increase from the center to both edge parts according to the illuminance distribution in the reading range 11.

The next is a description on FIG. 4B which show a shading characteristic, attributable to the lens 2b of the imaging unit 2, occurring on the light reception surface of the line sensor 2a.

Referring to FIG. 4B, the horizontal axis indicates the position of the light reception face (i.e., the distance from the edge on one side of the light reception face linearly formed) of the line sensor 2a and the vertical axis indicates the light intensity incident at the position. This diagram provides a comprehension that the light intensity incident to the light reception surface of the line sensor 2a in the maximum in the center part, with a gradual decrease from the center part to both edge parts due to a shading characteristic attributable to the lens 2b. That is, the characteristic takes on a tendency reverse to the illuminance distribution in the reading range shown in FIG. 4A.

The next is a description on FIG. 4C which shows an intensity distribution of an illumination light on the light reception surface of the line sensor 2a in the case of emitting an illumination light on the recording medium 8 by placing the imaging unit 2 and lighting unit 3 in the relationship as shown in FIGS. 3A and 3B.

In the showing of FIG. 4C, the horizontal axis indicates the position of the light reception face (i.e., the distance from the edge on one side of the light reception face linearly formed) of the line sensor 2a and the vertical axis indicates the intensity of illumination light at the position. This diagram provides a comprehension that the intensity of the illumination light at the position of the light reception face of the line sensor 2a indicates a flat characteristic in this case.

A shading characteristic of a lens is generally proportionate to approximately the fourth power of cos θ (where θ is a half of an angle of view). Accordingly, a setup of an illuminance distribution in terms of a view angle within the reading range 11 as 1/(cos θ)⁴ makes the intensity distribution of the illumination light on the light reception face of the line sensor 2a theoretically flat. An emission of the illumination light on the recording medium 8 by placing the imaging unit 2 and lighting unit 3 in the relationship as shown in FIGS. 3A and 3B makes it possible to provide the reading range 11 with exactly such an illuminance distribution.

Such compensation of the nonuniformity of brightness distribution attributable to the shading characteristic of the lens 2b in a pickup image at the imaging unit 2 enables the imaging unit 2 to obtain image data of a uniform distribution of S/N independent of the reading position. This accordingly obtains an effect of the accuracy of a record defect detection being constant regardless of the reading position.

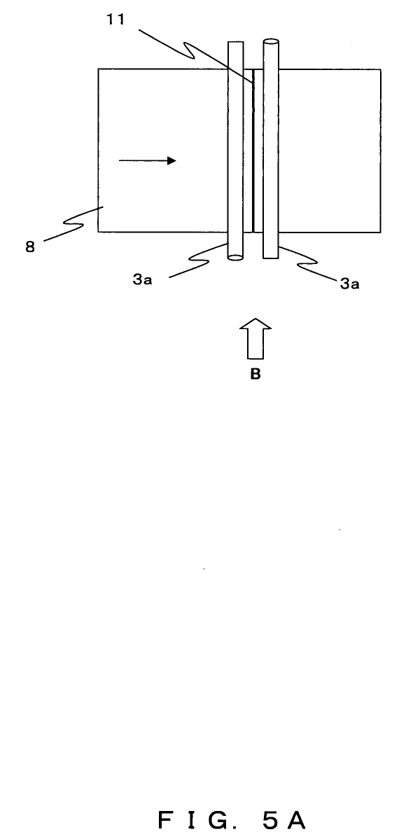

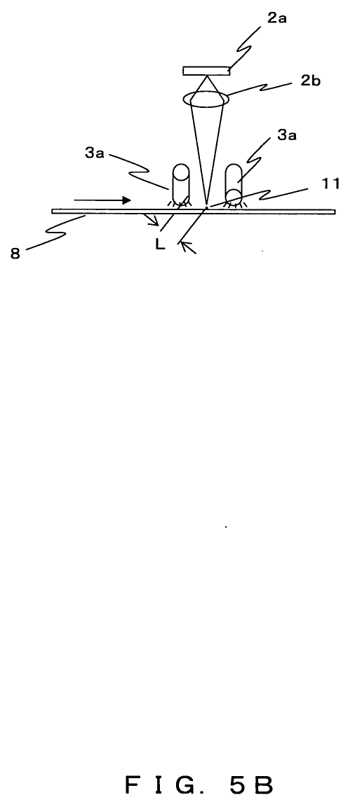

Note that the relationship of a placement between the imaging unit 2 and lighting unit 3 for providing the reading range 11 with an illuminance distribution compensating the nonuniformity of a brightness distribution attributable to the shading characteristic of the lens 2b at the imaging unit 2 and lighting unit 3 can be implemented by a relationship other than the one shown in FIGS. 3A and 3B. A second example of such a relationship of the placement between the imaging unit 2 and lighting unit 3 is shown in FIGS. 5A and 5B.

FIG. 5A is a diagram when viewing from a direction perpendicular to the surface of the recording medium 8; and FIG. 5B is a diagram when viewing from the direction of the arrow A indicated in FIG. 5A.

In the second example, the light source pair 3a is placed by maintaining the positional relationship thereof to be mutually parallel across the reading range 11 when viewing from a direction perpendicular to the surface of the recording medium 8 and also in parallel with the cross-feed direction. When viewing from the feed direction, however, the light source pair 3a is placed in mutually reversely inclination. Here, the distance between the edge of the reading range 11 and one of the light source pair 3a (i.e., the one closer to the aforementioned edge) is set to be L when viewing from the cross-feed direction. That is, in the second example, each of the light source pair 3a emitting light linearly is placed in mutually reversely inclination relative to the cross-feed direction in the position across from the reading range 11 while maintaining in parallel with the plane crossing in right angles with the surface of the recording medium 8.

Even if the illumination light is emitted on the recording medium 8 by placing the imaging unit 2 and lighting unit 3 in the positional relationship as shown in FIGS. 5A and 5B, the illuminance distribution in terms of the view angle in the reading range 11 is approximately 1/(cos θ)⁴, thereby making the intensity distribution of the illumination light on the light reception face of the line sensor 2a theoretically flat. That is, even if the relationship of placements between the imaging unit 2 and lighting unit 3 is configured as described above, it is still possible to provide the reading range 11 with an illuminance distribution compensating the nonuniformity of an intensity distribution, in a pickup image at the imaging unit, attributable to the shading characteristic of the lens 2b.

The next is a description on the method for detecting a record defect by the record defect detection apparatus 1.

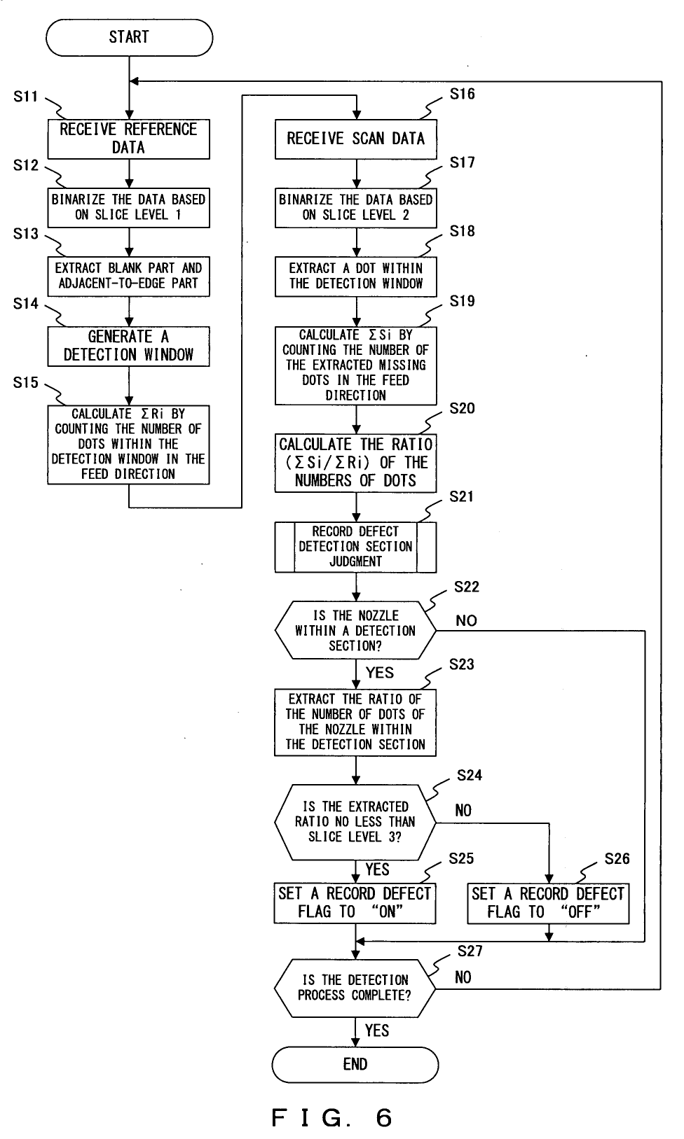

FIG. 6 is a diagram showing a process content, in a flow chart, of a record defect detection process according to the first embodiment of the present invention. The control unit 5 has the MPU read, and execute, the control program stored in the ROM, thereby being enabled to perform the record defect detection process, and to function as the record defect nozzle judgment unit 6.

Note that the following description names the image data sent from the host apparatus 7 as “reference data”. The reference data is premised to possess a total of 24 bits of data for each pixel that is the data of 8 bits (i.e., 256 tones) for each color, i.e., RGB. Here, in the pixel data of respective colors of RGB expressed by 8 bits, the brightness value of a pixel with the lowest brightness is defined as “1” and that of a pixel with the highest brightness is defined as “256”. Also, in a recording medium 8 to which an appropriate recording process is applied on the basis of the reference data, the tone of a recorded dot corresponding to the pixel data with the lowest brightness value (i.e., “1”) is expressed as “black”. Furthermore, in a recording medium 8 to which an appropriate recording process is applied on the basis of the reference data, the tone of a recorded dot corresponding to the pixel data with the highest brightness (i.e., “256”) is expressed as “white”. When a recording process is appropriately applied on the basis of the reference data, however, a recorded dot corresponding to the pixel data with the highest brightness value constitutes a non-record dot (i.e., a dot for which an ink droplet to be landed on the recording medium is fundamentally not jetted).

Referring to FIG. 6, the control unit 5 first performs the process for receiving reference data from the host apparatus 7 in the step S11.

Then, the control unit 5 performs the process for binarizing the reference data for each color of RGB based on a result of comparing, for each pixel, the size of the tonal value indicated by the pixel data of each color of RGB with the threshold value that is “slice level 1” in the step S12. Then, the control unit 5 performs the process for extracting a blank part and an adjacent-to-edge part from the binarized reference data of each color of RGB in the subsequent step S13. Then, the control unit 5 performs the process for removing the extracted blank part and adjacent-to-edge part from the binarized reference data for each color of RGB and generating a detection window for each color of RGB in the step S14.

The next is further description of the processes of the steps S12 through S14 noted above.

If the tonal value of pixel data is too large, a visual comparison between a recorded dot corresponding to the pixel data and a recorded dot of white (i.e., a non-record dot) corresponding to the pixel data with the maximum tonal value cannot distinguish one from another, hence it is difficult to detect a record defect. Therefore, the binarization process of the step S12 is carried out for making it possible to handle image zones constituted by recoded dots corresponding to the pixel data with such a remarkably large tonal value and to the pixel data with the maximum tonal value, as “blank parts”. Note that a value of the threshold value “slice level 1” can be set to be “246” for example, or another value can be set in accordance with accuracy of obtaining image data at the imaging unit 2.

As described above, the blank part is a non-record image zone in which an ink is fundamentally not jetted or an image zone in which a detection of a record defect is very difficult. Therefore, a detection of a record defect is not necessary for such an image zone, so a pixel(s) corresponding to the blank part is accordingly removed from the binarized reference data by the process of the steps S13 and S14.

Meanwhile, performed in a process described later is the process for detecting a missing ink dot from the image data obtained at the imaging unit 2. In the detection process, if a recorded dot recorded on the post-recording process recording medium 8 is adjacent to a dot that is a blank part, there is a case of erroneously detecting the recorded dot as a missing dot. Therefore, the processes of the steps S13 and S14 remove, from the binarized reference data, also the pixel data corresponding to the adjacent-to-edge part constituted by the recorded dot adjacent to the dot that is a blank part.

Such removal of the blank part and adjacent-to-edge part from a subject of detecting a record defect alleviates a load on the process for a record defect detection for the control unit 5 and also eliminates a risk of an erroneous detection which possibly happens when performing an operation of detecting a record defect for the blank part and adjacent-to-edge part.

Note that, if a method of an erroneous detection in an adjacent-to-edge part being sufficiently few can be used in the process for detecting a missing ink dot from image data obtained at the imaging unit, the process for removing the adjacent-to-edge part from a subject of detecting a record defect can be eliminated.

A detection window for detecting a recorded dot as a subject of detecting (also noted as “detection subject” hereinafter) a record defect from the image data obtained at the imaging unit 2 is generated by removing the blank part and adjacent-to-edge part from the binarized reference data as described above.

Now the description returns to FIG. 6. The control unit 5 performs the process for calculating the number of dots, i.e., ΣRi, as the detection subject for each inkjet nozzle by counting, in the feed direction, the number of recorded dots constituting the generated detection window for each color of PGB in the step S15. Note that the calculation of the number of dots ΣRi as the detection subject can use an increment counter of merely a simple configuration.

The control unit 5 performs, in the step S16, the process for receiving the image data of the detection image obtained at the imaging unit 2, that is, the image data of a processed image recorded on the recording medium 8 to which a recording process has been applied. Incidentally, the assumption here is that the image data of a detection image which is read at the imaging unit 2 by using the lighting unit 3 as light source is reproduced in a state of being approximately the same as the reference data by virtue of a correction at an image correction unit (not shown in a drawing herein). Note that the following description names the corrected image data as “scan data”.

The control unit 5 performs, in the step S17, the process for binarizing the scan data for each color of RGB based on a result of comparing, for each pixel, the size of the tonal value indicated by the pixel data of each color of RGB with the threshold value that is “slice level 2”.

The binarization process in the step S17 is for making it possible to handle, of the scan data, image zones constituted by recoded dots corresponding to the pixel data with such a remarkably large tonal value and to the pixel data with the maximum tonal value as “blank parts”. Incidentally, considering similarly to the setup of the threshold value “slice level 1”, a value of the threshold value “slice level 2” can also be set to be “246” for example, or another value can be set in accordance with accuracy of obtaining image data at the imaging unit 2.

Then, the control unit 5 performs, in the step S18, the process for extracting a recorded dot as the subject of detecting a record defect from the binarized scan data of each color based on the detection window generated by the process of the step S14. This process extracts, from the scan data, a recorded dot, of which the position is included in the detection window, from among the recorded dots.

Then, the control unit 5 performs, in the step S19, the process for calculating the number of missing dots, i.e., ΣSi, for each inkjet nozzle by counting the number of missing dots in the extracted recorded dots for each color of RGB in the feed direction. The calculation of the number of missing dots ΣSi also can use an increment counter of a very simple configuration.

Then, the control unit 5 performs, in the step S20, the process for calculating, for each inkjet nozzle, a value of the ratio (ΣSi/ΣRi) of the number of missing dots ΣSi calculated by the process of the step S19 to the number of detection subject dots ΣRi calculated by the process of the step S15.

Then, the control unit 5 performs, in the step S21, the record defect detection section judgment process. This process is for judging whether or not to judge an inkjet defect for each nozzle based on the number of trials of ink jetting at each nozzle, the detail of which is described later.

Then, the control unit 5 performs, in the step S22, the process for discerning a nozzle within a detection section, that is, one capable of performing a proper defect judgment from a nozzle on the outside of a detection section, that is, one incapable of performing a proper defect judgment as yet on the basis of the result of the record defect detection section judgment process noted above. Here, the control unit 5 judges a nozzle within the detection section to be a “nozzle of a subject of a defect detection judgment” (also simply noted as “judgment subject nozzle” hereinafter) and accordingly performs the process of the step 23, while the nozzle on the outside of the detection section to be not a nozzle of a subject of a defect detection judgment and accordingly performs the process of the step 27.

Then, the control unit 5 performs, in the step S23, the process for extracting a value of the ratio of a recorded dot recorded by an ink droplet jetted from a judgment subject nozzle from among the values of the ratio (ΣSi/ΣRi) of the number of missing dots to the number of detection subject dots calculated by the process of the step S20. Then, the control unit 5 performs, in the subsequent step S24, the process for judging whether or not the extracted value of the ratio (ΣSi/ΣRi) is no less than a prescribed threshold value “slice level 3”.

Judging that the extracted value of the ratio (ΣSi/ΣRi) is no less than the “slice level 3” in the judgment of the step S24 (i.e., the judgment result is “yes”), the control unit 5 proceeds the process to the step S25. Contrarily, judging that the extracted value of the ratio (ΣSi/ΣRi) is less than the “slice level 3” in the judgment of the step S24 (i.e., the judgment result is “no”), the control unit 5 proceeds the process to the step S26.

The control unit 5 performs, in the step S25, the process for setting, to “on”, a record defect flag which is a flag for indicating that there is the number, which is no less than a predetermined value, of missing dots in the recorded dots of ink droplets jetted from a judgment subject nozzle so that the aforementioned nozzle is defective, followed by proceeding the process to the step S27.

The control unit 5 performs, in the step S26, the process for setting, to “off”, a record defect flag since the number of mission dots of occurrence in the recorded dots by ink droplets jetted from the judgment subject nozzle is less than a predetermined value.

The control unit 5 performs, in the step S27, the process for judging whether or not a signal indicating a completion (noted as “completion signal” hereinafter) of the record defect detection process has been received from the host apparatus 7. Here, judging that the completion signal of the record defect detection process has been received, the control unit 5 finishes the present record defect detection process. Contrarily, judging that a completion signal of the record defect detection process has not been received, the control unit 5 returns the process to the step S11 for repeating the processes described above.

Such is the record defect detection process. By carrying out the processes described above, the control unit 5 judges a presence or absence of a record defect based on the comparison result between the reference data and scan data and functions as the record defect nozzle judgment unit 6.

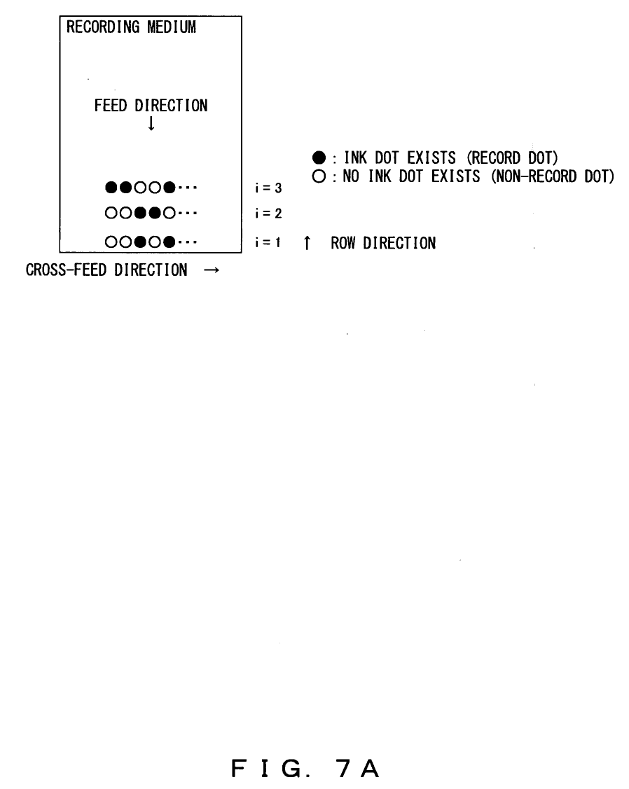

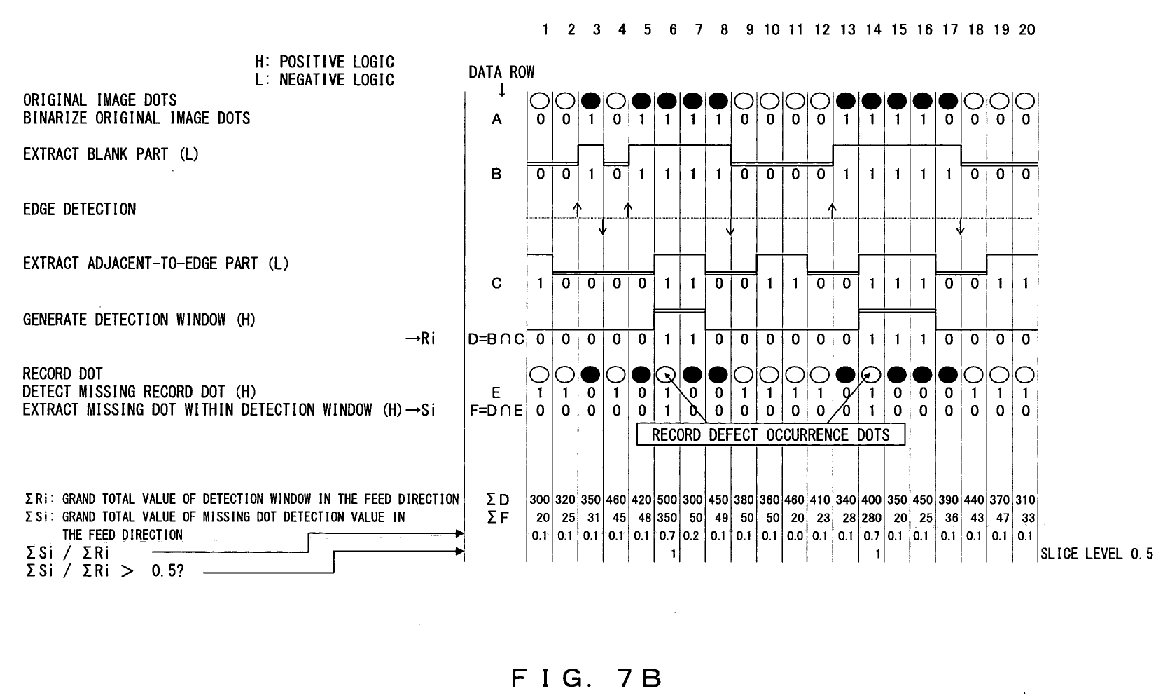

The next is a description of a situation of a jetting failure nozzle being detected from the reference data and scan data by performing the record defect detection process by referring to FIGS. 7A and 7B.

FIG. 7A show an example of scan data obtained at the control unit 5. FIG. 7A expresses a dot string recorded on the recording medium along the nozzle array arrayed in the cross-feed direction in the row direction in time series, i.e., i=1, 2, 3 and so on. And the black circle in the diagram represents a record dot (or a recorded dot), while the white circle represents a non-record dot, that is, a dot of which the tonal value is the maximum (i.e., 256).

FIG. 7B shows a situation of the scan data exemplified in FIG. 7A being processed by the record defect detection process shown in FIG. 6.

Referring to FIG. 7B, the line of “original image dots” shows, by the black circles and white circles, a pixel data string of reference data corresponding to the dot string of the row of i=1 in the scan data exemplified in FIG. 7A.

The result of performing a binarization process, of the step S12 shown in FIG. 6, to the “original image dots” is the data “A” of line of “Binarize original image dots”. Note that in the data “A”, the pixel data of which the tonal value is larger than the slice level 1 described above is converted into “0”, and the tonal value is no larger than the slice level 1 is converted into “1”.

The data “B” shown in the line of “Extract a blank part (L)” is data indicating a blank part extracted from the aforementioned data “A” by the process of the step S13 shown in FIG. 6. Incidentally, the data “B” represents the blank part by a negative logic and therefore a “0” in the data “B” represents the dot position of a blank part.

In the line of “edge detection”, shown is an arrow indicating an existence of an edge in a position where the “0” and “1” are adjacent to each other in the data “B”. In the step S13 shown in FIG. 6, first performed is the process for detecting the position of the edge, followed by detecting dots adjacent to both sides of the edge and extracting an adjacent-to-edge part. Thus obtained data is the data “C” shown in the line of “extract adjacent-to-edge part (L)”. Note that the data “C” expresses an adjacent-to-edge part by the negative logic and therefore the “0” in the data “C” represents the dot position of an adjacent-to-edge part.

Calculating the logic product of thus obtained data “B” and data “C”, the data “D” shown in the line of “Generate detection window (H)” is generated as detection window. The process of the step S14 shown in FIG. 6 generates a detection window as described above. Incidentally, the data “D” expresses the dot position within the detection window by the positive logic. Therefore, the distribution of the positions of “1” in the data “D” represents the distribution of the positions where the dots are formed by jetting the ink within the detection window. Meanwhile, the process of the step S16 shown in FIG. 6 counts the number of dots indicating “1” in the data “D” in the feed direction, thereby calculating the number of detection subject dots ΣRi for each ink jetting nozzle.

The line of “record dot” shows a dot string of the row i=1 in the scan data exemplified in FIG. 7A.

The result of performing a binarization process of the step S17 shown in FIG. 6 to the “record dot” is the data “E” of the line “detect missing record dot (H)” in FIG. 7. Note that in the data “E”, the pixel data of which the tonal value is larger than the slice level 1 described above is converted into “1”, and the tonal value is no larger than the slice level 1 is converted into “0”. Therefore, the distribution of positions of “0” in the data “E” represents the distribution of the positions of the dots recorded in the recording medium 8 as a result of jetting ink. Also, a dot (i.e., a blank dot) which is a blank part and a dot (i.e., a missing record dot) in which a record defect has occurred due to a jetting failure of a nozzle exist in recorded dots corresponding to the image data indicated by “1” in the data “E”.

Calculating the logic product of the thusly obtained data “E” and the data “D” that is the detection window in order to compare between the two kinds of data, then data “F” shown in the line “Extract missing dot within detection window (H)” is generated as comparison result. The step S18 of FIG. 6 performs the process and, as a result, a dot indicated by “1” in the data “F” represents a missing record dot, which constitutes the detection result of a record defect. And the process of the step S19 shown in FIG. 6 counts the number of dots indicated by “1” in the data “F” in the feed direction, thereby calculating the number of missing dots ΣSi for each ink jetting nozzle.

The next is a description of an operation for detecting a record defect based on the ratio of the number of missing dots ΣSi to the number of detection subject dots ΣRi for each ink jetting nozzle.

FIG. 7B shows a calculation result of ΣRi for each ink jetting nozzle as data “ΣD” and that of ΣSi for each ink jetting nozzle as data “ΣF”.

Here, the sixth nozzle of FIG. 7B is focused as an example. The calculation result of the ΣRi of the nozzle is “500” and that of the ΣSi is “350”. In this event, the calculation result of the ratio (i.e., a value of ΣSi/ΣRi) which is calculated by the process of the step S23 of FIG. 6 is “0.7”.

Then, the seventh nozzle of FIG. 7B is focused. The calculation result of the ΣRi of the nozzle is “300” and that of the ΣSi is “50”. In this event, the calculation result of the ratio (i.e., a value of ΣSi/ΣRi) which is calculated by the process of the step S23 of FIG. 6 is “0.2”.

In this case, setting a value of the above described slice level 3 at “0.5”, the judgment process in the step S24 judges “yes” for the sixth nozzle and accordingly a record defect, while “no” for the seventh nozzle and accordingly not a record defect.

As such, a judgment based on the ratio of the number of missing dots ΣSi to the number of detection subject dots ΣRi for each ink jetting nozzle which are counted in the feed direction makes it possible to detect a jetting failure of the corresponding ink jetting nozzle in high accuracy.

The next is a description on a record defect detection section judgment process that is shown in the step S21 of FIG. 6. Carrying out the process, the control unit 5 judges, for each nozzle, whether or not the number of pixel data sufficient for detecting a nozzle of an ink jetting failure has been included in the reference data. The purpose of this process is to enable an appropriate judgment of an ink jetting failure for each nozzle even if the image represented by the reference data requires a large difference in the numbers of necessary ink jetting times for the individual nozzles.

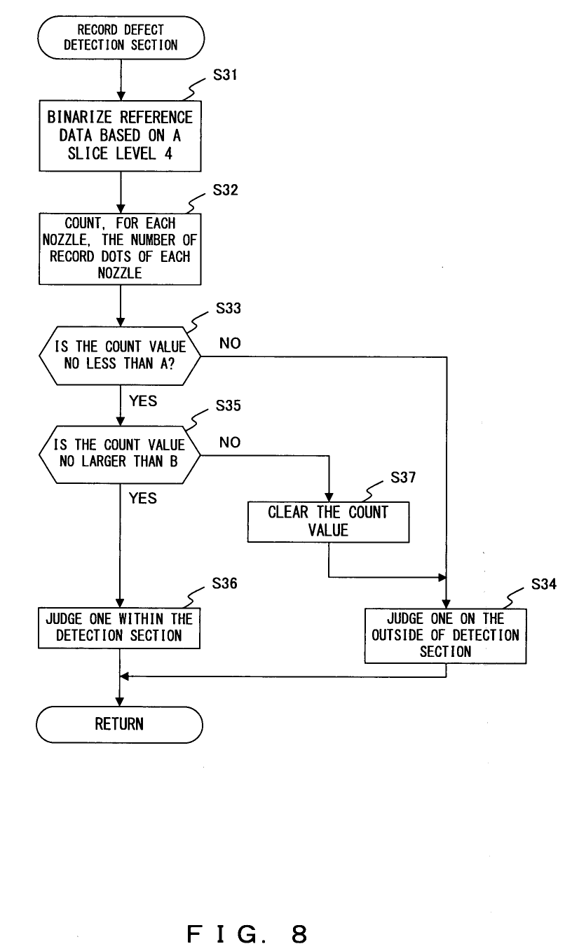

A description now is on FIG. 8 which is a diagram showing a process content of a record defect detection section judgment process in a flow chart.

First, the control unit 5 performs, in the step S31, the process for binarizing the reference data for each color of RGB based on a result of comparing, for each pixel, the size of the tonal value indicated by the pixel data of each color of RGB with the threshold value that is “slice level 4”.

The binarization process is for making it possible to handle, of the reference data, image zones constituted by recoded dots corresponding to the pixel data with a remarkably large tonal value and to the pixel data with the maximum tonal value as “blank parts”.

Note that a setup of the threshold value “slice level 4” at about normal 236 to 246, with the tonal value of a blank part being 256, makes it possible to judge a record defect effectively for a recorded dot of a density in a visually recognizable level.

Incidentally, a configuration may alternatively be in a manner to set the threshold value “slice level 4” arbitrarily. Such a configuration enables the record defect detection apparatus 1 to have the function as control equipment managing an availability ratio and record quality arbitrarily. That is, a decrease of the threshold value for example enables the record defect detection apparatus 1 to perform a management such as making an image recording apparatus with a high occurrence ratio of record defect hard to judge a record defect.

Then, the control unit 5 performs, in the step S32, the process for counting, for each ink jetting nozzle, the number of pieces of pixel data corresponding to a recorded dot (i.e., a dot which is not included in a blank part) in the binarized reference data of each color of RGB by using a record counter.

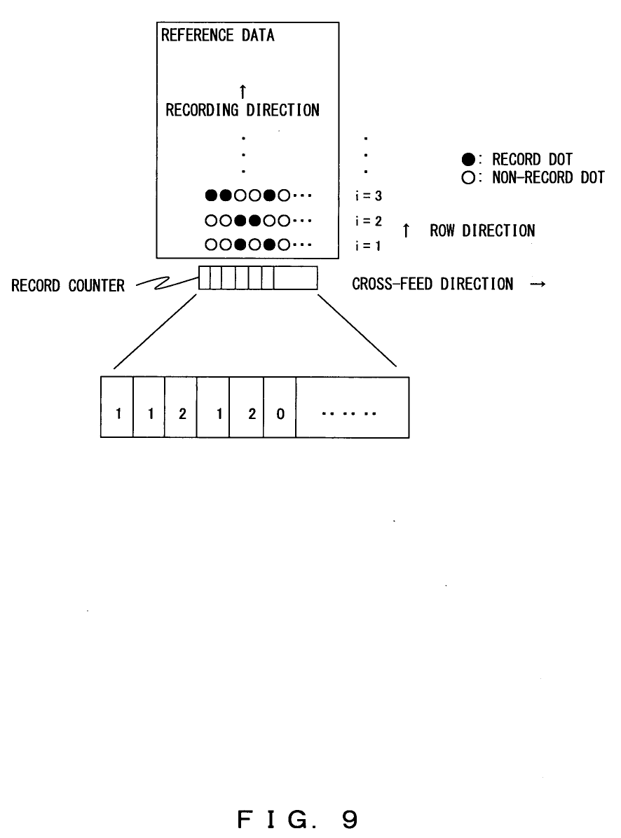

At this time, a description turns to the record counter by referring to FIG. 9.

In the binarized reference data shown in FIG. 9, a black circle indicates a piece of pixel data corresponding a recorded dot, and a while circle indicates a piece of pixel data corresponding a non-record dot (i.e., a dot included in a blank part). If the reference data is appropriately recorded, ink dots are recorded in two-dimensionally in accordance with the image pattern, with the interval of the ink dots in this case being 84.7 micrometers for a record density of 300 dots per inch (dpi) for instance. Incidentally, FIG. 9 shows the reference data equivalent of three rows of data.

Focusing on one of the inkjet nozzles, there is a nozzle not jetting an ink droplet at all in any of the rows depending on an image pattern of the reference data, and there is a nozzle jetting an ink droplet continuously in all rows in the case of a solid pattern as an example. The record counter counts, for each nozzle, the number of times of ink droplet jetting that is to be jetted when carrying out a recording process appropriately on the basis of the reference data.

The record counter shown in FIG. 9 indicates a count value of each nozzle when counting the exemplified reference data for three rows. That is, the record counter is configured to count, for each nozzle, the number of black circle of each row of the reference data, that is, the number of pieces of pixel data corresponding to the dots to be recorded.

Now the description returns to FIG. 8.

The control unit 5 performs, in the step S33, the process for discerning between a nozzle of which a count value on the record counter is no less than a predefined value A and a nozzle of which the count value is less than the predefined value A. Here, the control unit 5 performs, in the step S34, the process for judging a nozzle of which the count value on the record counter is less than the predefined value A as a nozzle on the outside of a detection section. Then the control unit 5 finishes the record defect detection section judgment process and shifts the process back to those of FIG. 6. Meanwhile, the control unit 5 applies the process of the step S35 to a nozzle of which the count value on the record counter is no less than the predefined value A.

Here, a value of A can be set to be about 100 for example. If a value of A is set to be “1” in this event, the detection of a missing record dot can be carried out in a time length which is required to convey the recording medium for a distance equivalent to one dot. This setup, however, increases a possibility of erroneously detecting a missing record dot. Contrarily, a setup of a value of A at about 100 deduces a possibility of erroneously detecting a missing record dot to 1/100, while the time required for detecting a missing record dot is 100 times the case of setting a value of A at “1”.

The control unit 5 performs, in the step S35, the process for discerning between a nozzle of which a count value on the record counter is no more than a predefined value B and a nozzle of which the count value is more than the predefined value B.

Here, the control unit 5 performs, in the step S36, the process for judging a nozzle of which a count value on the record counter is no more than the predefined value B as a nozzle within the detection section. In other word, the control unit 5 applies the processes of the steps 23 through S26 shown in FIG. 6 to a nozzle of which the number of times of jetting ink droplets described above is included in the range determined by the predefined values of A and B.

Then, the control unit 5 finishes the record defect detection section judgment process and returns to the process of FIG. 6.

Meanwhile, the control unit 5 applies the process of the step S37 to a nozzle of which the count value on the record counter is larger than the predefined value B. Note that a value of B can be set at about 200 for instance.

The control unit 5 performs, in the step S37, the process for clearing the count value for a nozzle of which the count value on the record counter is larger than the predefined value B. Then the control unit 6 proceeds to the process of the step S34 and performs the process for judging the nozzle as one on the outside of the detection section. Then, it finishes the record defect detection section judgment process and returns to the process of FIG. 6.

Such is the record defect detection section judgment process. The control unit 5 carrying out the process as that of the step S21 of FIG. 6 makes it possible to limit, to a certain level or less, the execution time length at the time of executing a detection of a record defect and the length, in the feed direction, of detection section as a detection subject of a record defect on the recording medium 8. Therefore, it is possible to avoid a degradation of accuracy of judgment, due to a fluctuation of some external factor, which is likely to occur when continuing a monitor of a record defect for a record of an image, in which the ratio of dots to be recorded is very low, for a long detection section or for an extended time period.

Note that it is possible to detect a record defect by using only the scan data, without using reference data, to some extent in the process shown in FIG. 6. For that, a detection window is not generated for instance and a value of ΣRi is set to be constant so that a nozzle of which a value of ΣSi is remarkably large is detected as nozzle of an ink jetting failure.

Meanwhile, it is possible to use an area sensor of a two-dimensional array in place of the line sensor 2a comprised by the imaging unit 2. Such a configuration enables a process operation similar to the case of the line sensor 2a by operating the area sensor so as to transfer scan data by one row of ink dots.

As described above, the present first embodiment is configured to be capable of detecting by not using a pattern matching requiring a complex process system, thus enabling a provision of a record defect detection apparatus detecting a record defect in high accuracy and speed by a simple comprisal.

It has also a capability of obtaining an image in which the brightness level and S/N are uniformed as a whole and therefore a highly accurate detection is enabled for a system such as one using a pickup image for a quantitative detection such as a record defect detection.

The next is a description on a second preferred embodiment of a record defect detection apparatus embodying the present invention.

Note that the same component sign is assigned to the constituent component common to the first embodiment described above and only the part(s) different from that of the first embodiment is described for the present second embodiment.

The conceptual block configuration of the record defect detection apparatus according to the present second embodiment is similar to that of the first embodiment shown in FIG. 1 and so is the layout of the respective constituent components to that of the first embodiment shown in FIG. 2.

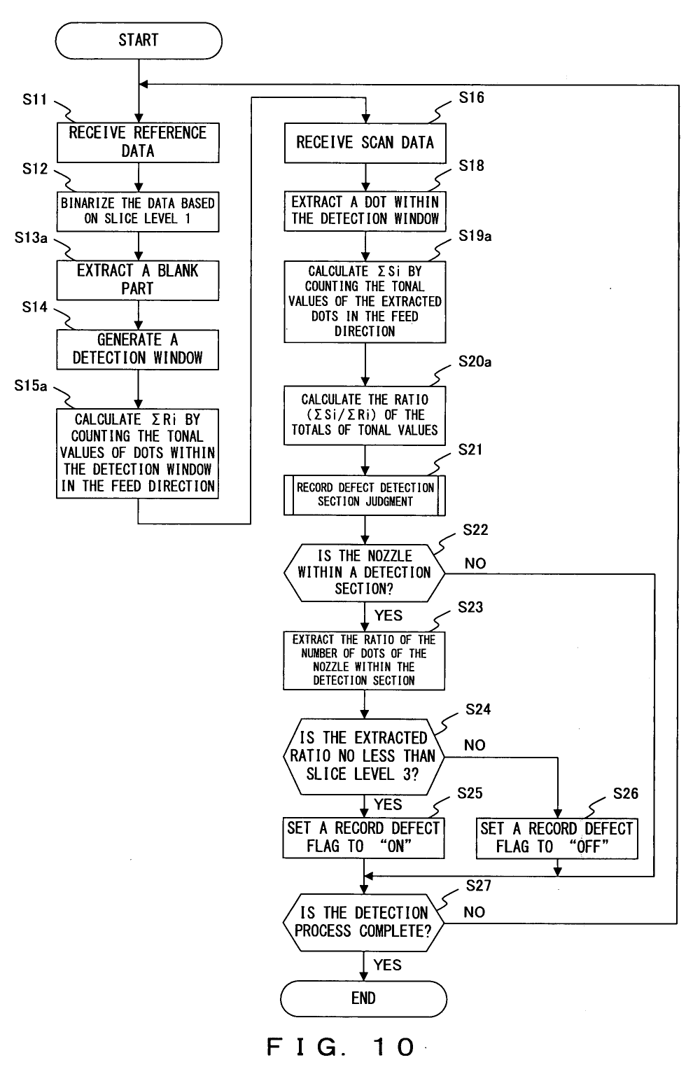

FIG. 10 is a diagram showing a process content, in a flow chart, of a record defect detection process according to a second preferred embodiment of the present invention. The control unit 5 has the MPU read, and execute, the control program stored in the ROM, thereby becoming capable of performing the record defect detection process and functioning as the record defect nozzle judgment unit 6.

In the process shown in FIG. 10, the steps S13a, S15a, S19a and S20a are different from the steps S13, S15, S19 and S20 in the record defect detection process according to the first embodiment of the present invention shown in FIG. 6. And the process shown in FIG. 10 has eliminated the process of the step S17 in the process shown in FIG. 6. The following is a description of the process shown in FIG. 10 by describing the different parts from the process shown in FIG. 6.

The control unit 5, in the step S13a following the process of the step S12, performs the process for extracting only a blank part from the binarized reference data of each color of RGB.

In the detection of a missing ink dot carried out in the record defect detection process shown in FIG. 10, even if a record dot recorded on the post-record process recording medium 8 is adjacent to a dot that is a blank part, the record dot is never detected to be a record dot erroneously. Therefore, an adjacent-to-edge part is not extracted from the reference data and instead only a blank part is extracted in the process of the step S13a.

The control unit 5, in the step S15a following the process of the step S14, performs the process for calculating the grand total, i.e., ΣRi, of tonal values of detection subject dots for each ink jetting nozzle. That is, the control unit 5 performs the process for totaling, in the feed direction, the tonal values of respective pieces of pixel data corresponding to record dots constituting the generated detection window of each color of RGB.

And, the control unit 5, in the step S19a following the process of the step S18, performs the process for totaling, in the feed direction, the tonal values of the record dots of each color of RGB extracted from the received scan data, thereby calculating the grand total, i.e., ΣSi, of the tonal value of the record dots of each ink jetting nozzle.

And, the control unit 5, in the step S20a, performs the process for calculating, for each ink jetting nozzle, a value of the ratio (ΣSi/ΣRi) of the grand total of the tonal values of record dots calculated in the step S19a to the grand total of the tonal values of the detection subject dots calculated in the step S15a.

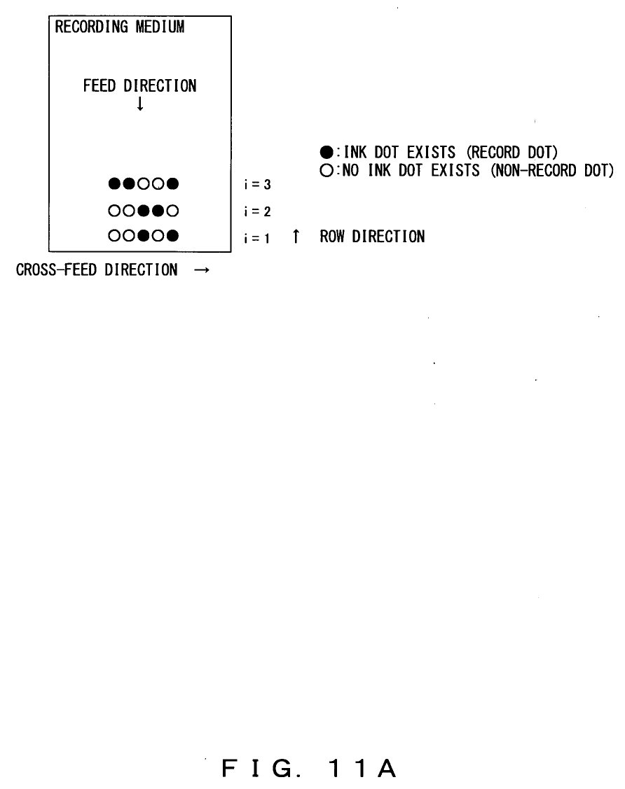

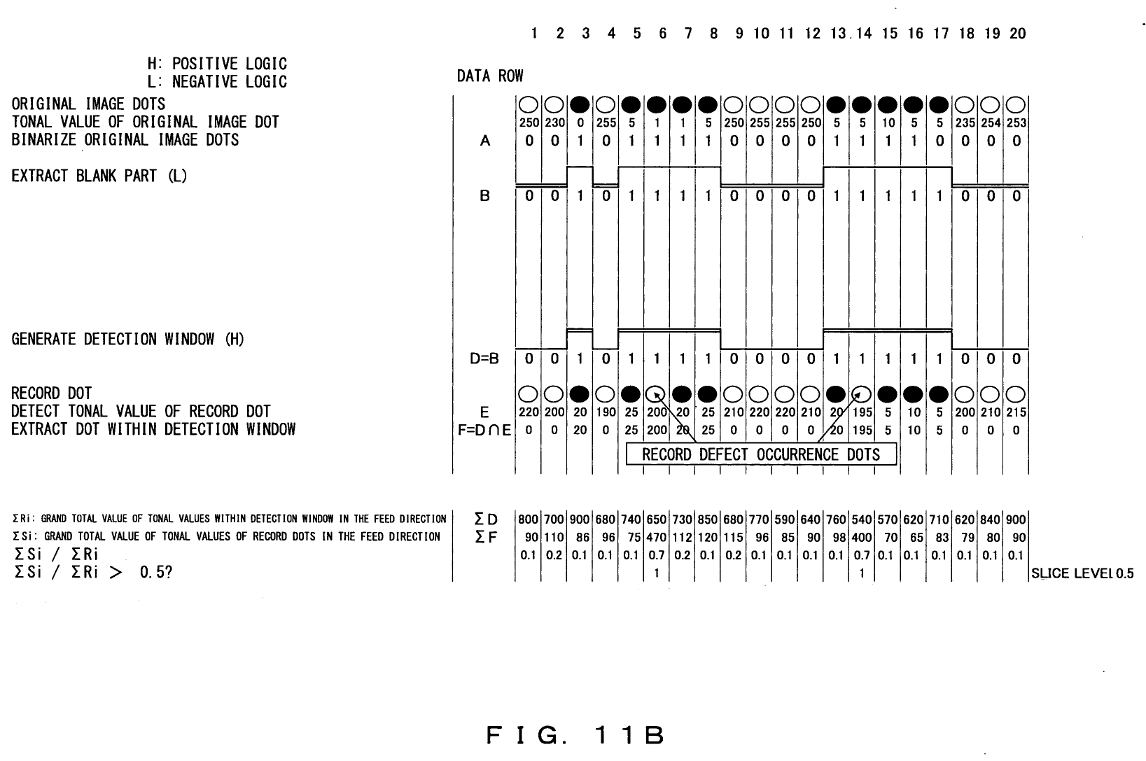

The next is a description of a situation of how a nozzle of a jetting failure is detected from the reference data and scan data by virtue of the record defect detection process shown in FIG. 10, by referring to FIGS. 11A and 11B.

FIG. 11A shows an example of scan data obtained at the control unit 5. FIG. 11A shows dot strings recorded on the recording medium 8 along the nozzle array arrayed in the cross-feed direction in the row direction of i=1, 2, 3, and so on, in time series. In the drawing, the black circle indicates a recorded dot, while the white circle indicates a non-record dot (i.e., a dot included in a blank part).

FIG. 11B shows a situation of the scan data exemplified in FIG. 11A being processed by the record defect detection process shown in FIG. 10.

Referring to FIG. 11B, the line of “original image dots” and that of “Extract a blank part (L)” are similar to those shown in FIG. 7B. And the line of “Tonal value of original image dots” in FIG. 11B exemplifies a tonal value of each piece of pixel data shown in the line of “original image dots”.

The data “B” shown in the line of “Extract a blank part (L)” is data indicating the blank part extracted from the data “A” described above. Note that the data “B” expresses a blank part in the negative logic, and accordingly the “0” of the data “B” indicates the dot position of the blank part.

The detection window generated by the process of the step S14 of FIG. 10 is the data “D” shown in the line of “Generate detection window (H)”. The distribution of positions of the data “D” indicates the distribution of positions, in the detection window, where the dots are recorded by jetting an ink.

As described above, the step S13a of FIG. 10 does not extract an adjacent-to-edge part and therefore the data “D” is equal to the data “B” of the line of “Extract a blank part (L)”. Note that the process of the step S15a of FIG. 10 calculates the tonal values of the individual pieces of pixel data corresponding to dots of “1” in the data “D” from the reference data and totals the obtained tonal values in the feed direction, thereby calculating the grand total ΣRi described above for each ink jetting nozzle.

The line of “record dot” shows the dot string of the i=1 row in the scan data exemplified in FIG. 11A by black and white circles. The data “E” shown in the line of “detect tonal value of record dot” exemplifies tonal values when the imaging unit 2 reads the individual dots shown in the line of “record dot”. Note that this example sets the tonal values of white dots at about the values of 190 to 220, while the tonal values of black dots at about 5 to 25. Therefore, the distribution of positions of tonal values being about 5 to 25 in the data “E” represents the distribution of positions of the dots recorded in the recording medium 8 as a result of jetting ink.

Calculating the logic product of the data “E” and the data “D” that is the detection window, the data “F” shown in the line of “Extract dots within detection window” is generated. The step S18 of FIG. 10 performs the process, generating the data “F” as a result of setting the tonal value of a white dot indicating “0” in the data “D” to be “0”. Therefore, the dots indicating the tonal values of about 190 to 220 in the data “F” represent missing record dots, which is the result of detecting a record defect.

Meanwhile, the process of the step S19a of FIG. 10 totals the tonal values shown in the data “F” in the feed direction, thereby calculating the grand total ΣSi described above for each ink jetting nozzle.

The next is a description of an operation for detecting a record defect based on the ratio, for each ink jetting nozzle, of the grand total ΣSi of the tonal values of record dots to the grand total ΣRi of the tonal values of the detection subject dots.

FIG. 11B shows the calculation result of the ΣRi for each ink jetting nozzle as data “ΣD” and that of the ΣSi for each ink jetting nozzle as “ΣF”.

Here, the sixth nozzle of FIG. 11B is focused as an example. The calculation result of the ΣRi of the nozzle is “650” and that of the ΣSi is “470”. Here, the calculation result of the ratio (i.e., the value of ΣSi/ΣRi), which is calculated by the process of the step S23 of FIG. 11, is “0.7”.

Next, the seventh nozzle of FIG. 11B is focused. The calculation result of ΣRi of the nozzle is “730” and that of the ΣSi is “112”. Here, the calculation result of the ratio (i.e., the value of ΣSi/ΣRi), which is calculated by the process of the step S23 of FIG. 11, is “0.2”.

In this case, if the value of the above described slice level 3 set at “0.5”, the judgment process of the step S24 of FIG. 11 judges the sixth nozzle “yes” and therefore a record defect, while the seventh nozzle as “no” and therefore not a record defect.

As such, a judgment based on the ratio, for each ink jetting nozzle, of the grand total ΣSi of the tonal values of record dots to the grand total ΣRi of the tonal values of the detection subject dots, both of which is totaled in the feed direction, makes it possible to detect a jetting failure of the corresponding ink jetting nozzle in high accuracy.

As described above, the present second embodiment is configured to judge a record defect based on the result of calculating the grand total of the tonal values of record dots in the feed direction. By this configuration, the present second embodiment makes it possible to detect a dot adjacent to a blank part as well, and suppresses an influence of an occurrence of noise at the time of a binarization process attributable to a tonal fluctuation of individual pixels included in an image. Therefore, the present second embodiment is configured to enable very accurate record defect detection.

The next is description on a preferred embodiment of an image recording apparatus according to the present invention. Note that the image recording apparatus is one incorporating the record defect detection apparatus according to the first or second embodiment described above.

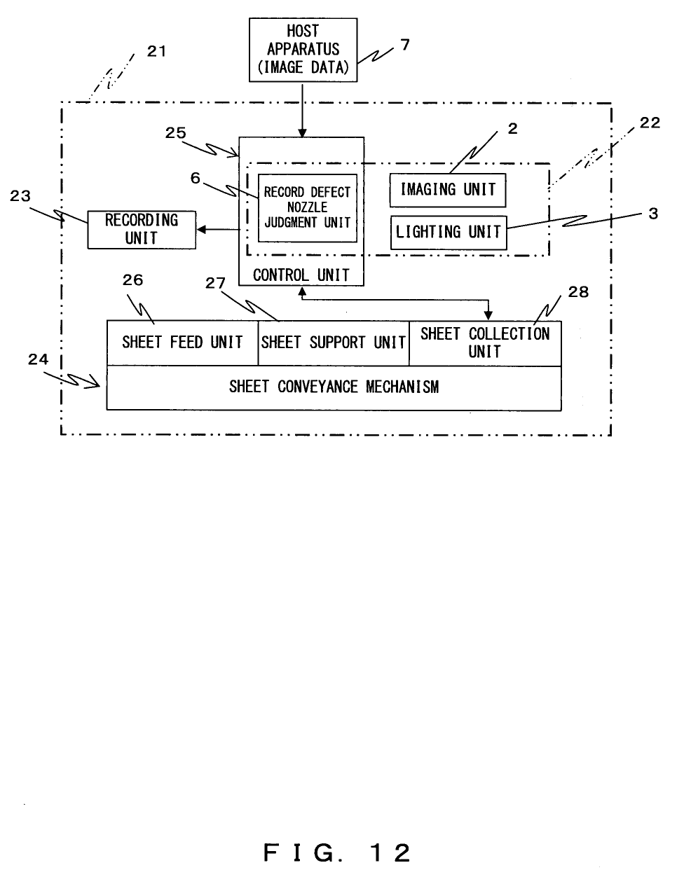

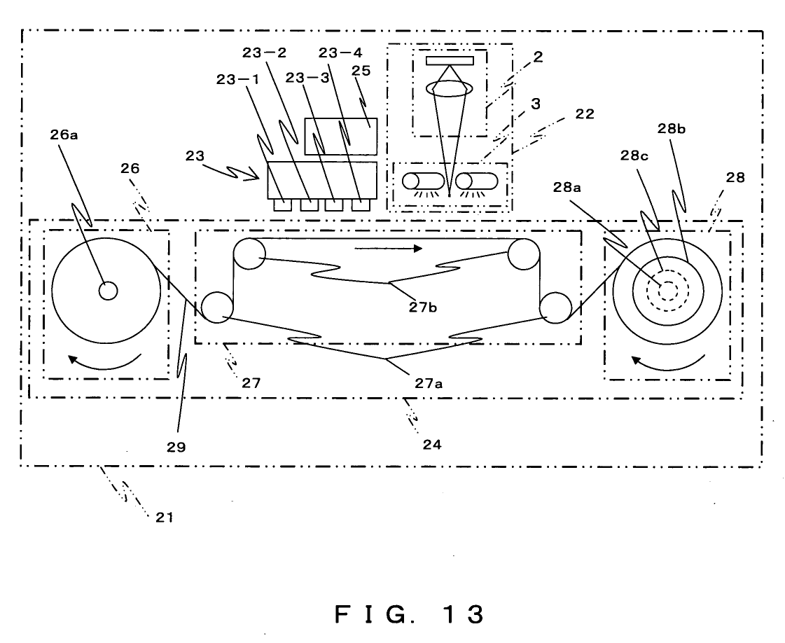

FIG. 12 is a block diagram showing a conceptual configuration of an image recording apparatus embodying the present invention; and FIG. 13 shows a layout of individual constituent components of an image recording apparatus embodying the present invention.

Note that the same component sign is assigned to the constituent component common to the first or second embodiment of the record defect detection apparatus described above, in the description of the present embodiment and a part different from the above embodiment is described here.

As shown in FIG. 12, the image recording apparatus 21 according to the present embodiment comprises a record defect detector 22.

Image data sent over from a host apparatus 7 transmitting original information to be recorded is input to a control unit 25. The control unit 25 has a usual control function for an image recording apparatus 21, such as a control for making a recording head of a recording unit 23 jet an ink in an appropriate mapping and density by expanding image data, a conveyance control for a sheet conveyance mechanism 24 and a control for adjusting a record timing with the recording head. The control unit 25 further performs a control process as the record defect nozzle judgment unit 6 and controls the record defect detector 22 constituted by the imaging unit 2, lighting unit 3 and record defect nozzle judgment unit 6. Furthermore, the control unit 25 controls an operation of the record defect detector 22 appropriately on the basis of the image data and the conveyance timing of the sheet conveyance mechanism 24, and integrally controls a post-process in the case of a record defect being judged.

The control unit 25 comprises a processing circuit constituted by a micro processor unit (MPU) that is an arithmetic logical operation apparatus possessing a control function and an arithmetic logical operation function and by read only memory (ROM) storing a control program, and comprises nonvolatile memory (not shown in a drawing herein) storing a setup value or the like related to the control of the recording apparatus. The control unit 25 has the MPU execute a prescribed control program, thereby implementing the various control process described above.

The sheet conveyance mechanism 24 comprises a sheet feed unit 26 for feeding a recording medium of a sheet form, a sheet collection unit 28 for collecting a recording medium, and a sheet support unit 27 for supporting a recording medium in a certain position in relation to the recording unit 23 and record defect detector 22.

Obtaining image data from the host apparatus 7, the control unit 25 stores the data temporarily in memory (not shown in a drawing herein) of the present control unit 25; and makes the recording unit 23 perform a recording process by notifying the recording unit 23 of image data of the first through nth lines (where “n” is an integer no less than “2”) of the image data.

The next is a continued description of the constituent components of the image recording apparatus 21 by referring to FIG. 13.

The sheet conveyance mechanism 24 comprises the sheet feed unit 26, sheet support unit 27 and sheet collection unit 28.

First, a recording medium 29 of a sheet form wound in a roll which is supported by the sheet support member 26a is fed out of the sheet feed unit 26. This prompts the sheet support unit 27, which is constituted by a sheet tension roller pair 27a and a sheet support roller pair 27b, to place the recording medium 29 tautly to a position accurately in relation to the record defect detector 22 comprising the recording unit 23, imaging unit 2 and lighting unit 3. Then the recording medium 29 is collected by the sheet collection unit 28 comprising a sheet support member 28a, a sheet conveyance information generation unit 28c and a sheet conveyance drive unit 28b.

The recording heads 23-1, 23-2, 23-3 and 23-4 of the recording unit 23 are placed on the upstream side (i.e., the sheet feed unit 26 side) on the surface of the recording medium 29 plainly expanded in relation to the sheet conveyance mechanism 24. Meanwhile, the record defect detector 22 is placed on the downstream side (i.e., the sheet collection unit 28 side) on the surface of the recording medium 29. Such a placement makes it possible to detect, in real time, a record condition of the recording medium 29 immediately after a recording process is applied thereto.

As described above, the placement of the record defect detector 22 as a part of the image recording apparatus 21 makes it possible to achieve the optimization of a layout and also maintain an image quality after a recording at the image recording apparatus 21 in high level.

As such, the record defect detection apparatus and image recording apparatus according to each preferred embodiment of the present invention are simply configured and yet to be capable of detecting a record defect in high accuracy and high speed.

The preferred embodiments of the present invention have been described thus far; the present invention, however, can be improved and/or changed in various manners possible within the scope of the present invention, in lieu of being limited to the embodiments described above. As an example, some constituent components may be eliminated from the overall comprisal put forth in the respective preferred embodiments of the present invention described above, or the different constituent components of the individual embodiments may be combined as appropriate.

Meanwhile, the respective embodiments of the present invention described above may alternatively be configured to apply a recording process of an inspection-use prescribed image (i.e., a test pattern) to a recording medium after a record defect is detected, and confirm the record result, thereby examining the record defect. Incidentally, an inspection-use image to be used in this case may be stored in the memory comprised by the apparatus itself, or an image sent over from a host apparatus may be obtained and used.

What is claimed is:

1. A record defect detection apparatus for detecting a record defect having occurred at the time of performing a recording process onto a recording medium, based on image data, by jetting an ink from individual nozzles of a nozzle array formed with a plurality of nozzles, comprising:
a lighting unit for emitting an illumination light onto the recording medium after performing the recording process;
an imaging unit for imaging, by way of a lens, the surface of the recording medium illuminated with the illumination light by the lighting unit and outputting a detection image;
a conveyance unit for conveying the recording medium while maintaining a relationship of a position where the surface of the recording medium is opposite to the imaging unit; and
a record defect judgment unit for judging a presence or absence of an occurrence of the record defect based on a result of the comparison between the image data and detection image, wherein
the lighting unit provides the surface of the recording medium with an illuminance distribution compensating, by an illumination of the illumination light, a nonuniformity of a brightness distribution in the detection image attributable to a shading characteristic of the lens.

2. The record defect detection apparatus according to claim 1, wherein
the lighting unit comprises two of a light source which is equipped in parallel with the surface of the recording medium and which emits linear light, wherein
the two light sources are equipped in parallel with each other in positions sandwiching the imaging zone of the imaging unit of the surface of the recording medium, and in inclination relative to a direction perpendicular to the conveyance direction of the recording medium by means of the conveyance unit.

3. The record defect detection apparatus according to claim 1, wherein
the lighting unit comprises two of a light source which is equipped in parallel with a flat surface orthogonal to the surface of the recording medium and which emits linear light, wherein
the two light sources are equipped in mutually reversely inclination relative to a direction perpendicular to the conveyance direction of the recording medium by means of the conveyance unit in positions sandwiching the imaging zone of the imaging unit of the surface of the recording medium.

4. The record defect detection apparatus according to claim 1, further comprising
a control unit functioning as the record defect judgment unit, wherein
the control unit comprises at least an arithmetic logical operation apparatus and a storage unit for pre-storing a control program to be executed by the aforementioned operation apparatus so as to function as the record defect detection unit as a result of the operation unit executing the control program.

5. A record defect detection method for detecting a record defect having occurred at the time of performing a recording process on a recording medium, based on image data, by jetting an ink from individual nozzles of a nozzle array formed with a plurality of nozzles, comprising:
obtaining processed image data recorded on the recording medium from the one for which the recording process is performed;
calculating a first distribution that is a distribution of positions of dots which are to be actually recorded on the recording medium if the recording process is performed in accordance with the image data based on a result of binarizing data, pixel by pixel, for at least one line of the image data;
calculating a second distribution that is a distribution of positions of dots recorded on the recording medium by performing the recording process based on a result of binarizing data, pixel by pixel, for at least one line of the processed image data;
comparing the first distribution with the second distribution; and
detecting the record defect based on the comparison result.

6. The record defect detection method according to claim 5, further comprising
determining the second distribution by calculating a distribution of positions included in a distribution of positions of dots indicated by the first distribution from among the positions of dots recorded in the recording medium as a result of performing the recording process.

7. The record defect detection method according to claim 5, further comprising
determining the number of first dots by calculating, for each nozzle, the number of dots which are to be actually recorded on the recording medium if the recording process is performed in accordance with the image data;
determining the number of second dots by calculating, for each nozzle, the number of dots recorded on the recording medium as a result of performing the recording process based on the second distribution;
calculating a value of the ratio of the number of first dots to that of the second dots; and
detecting the record defect based on the value of the ratio by determining the value of the ratio to be the result of the comparison.

8. The record defect detection method according to claim 7, further comprising
calculating, for each nozzle, the number of ink jetting which are to be actually performed if the recording process is carried out on the basis of the image data based on the result of binarizing the image data pixel by pixel; and
detecting the record defect if the number of jetting is within a prescribed range.

9. A record defect detection method for detecting a record defect having occurred at the time of performing a recording process on a recording medium, based on image data, by jetting an ink from individual nozzles of a nozzle array formed with a plurality of nozzles, comprising:
obtaining processed image data recorded on the recording medium from the one for which the recording process is performed;
calculating a first distribution that is a distribution of positions of dots which are to be actually recorded on the recording medium if the recording process is performed in accordance with the image data based on a result of binarizing data, pixel by pixel, for at least one line of the image data;
calculating a brightness value of pixel data corresponding to the dots within the first distribution based on the image data;
determining the grand total of first brightness values by calculating, for each nozzle, the grand total of the brightness values calculated for the dots within the first distribution;
calculating the second distribution, which is the distribution of positions of dots recorded on the recording medium by performing the recording process, based on the processed image data;
calculating brightness values of image data corresponding to the dots within the second distribution based on the processed image data;
determining the grand total of second brightness values by calculating, for each nozzle, the grand total of the brightness values calculated for the dots within the second distribution;
calculating, for each nozzle, a value of the ratio of the grand total of the first brightness values to that of the second brightness values; and
detecting the record defect based on the value of the ratio.

10. An image recording apparatus performing a recording process onto a recording medium, based on an image data, by jetting an ink from each nozzle of a nozzle array formed with a plurality of nozzles, comprising:
a lighting unit for emitting an illumination light onto the surface of the recording medium after the recording process is performed;
an imaging unit for outputting, by way of a lens, a detection image of the surface of the recording medium to which the illumination light is illuminated by the lighting unit;
a conveyance unit for conveying the recording medium while maintaining a relationship of a position where the surface of the recording medium is opposite to the imaging unit; and
a record defect judgment unit for judging a presence or absence of an occurrence of the record defect having occurred at the time of performing the recording process onto the recording medium based on a result of the comparison between the image data and detection image, wherein
the lighting unit provides the surface of the recording medium with an illuminance distribution compensating a nonuniformity of a brightness distribution in the detection image attributable to a shading characteristic of the lens by an illumination of the illumination light.

11. The image recording apparatus according to claim 10, wherein
the lighting unit comprises two of a light source which is equipped in parallel with the surface of the recording medium and which emits linear light, wherein
the two light sources are equipped in parallel with each other in positions sandwiching the imaging zone of the imaging unit of the surface of the recording medium, and in inclination relative to the direction perpendicular to the conveyance direction of the recording medium by means of the conveyance unit.

12. The image recording apparatus according to claim 10, wherein
the lighting unit comprises two of a light source which is equipped in parallel with the surface of the recording medium and which emits linear light, wherein
the two light sources are equipped in mutually reversely inclination relative to a direction perpendicular to the conveyance direction of the recording medium by means of the conveyance unit in positions sandwiching the imaging zone of the imaging unit of the surface of the recording medium.

13. The image recording apparatus according to claim 10, further comprising
a control unit functioning as the record defect judgment unit, wherein
the control unit comprises at least an arithmetic logical operation apparatus and a storage unit for pre-storing a control program to be executed by the aforementioned operation apparatus so as to function as the record defect detection unit as a result of the operation unit executing the control program.
